(19) United States
(12) Patent Application Publication
(10) Pub. No.: US 2008/0255987 A1
(43) Pub. Date: Oct. 16, 2008

(54) Composite Settlement System

(75) Inventor: Shuhei OTSU, Chuo-ku (JP)

Correspondence Address: SHELDON MAK ROSE & ANDERSON PC, 100 Corson Street, Third Floor, PASADENA, CA, 91103-3842, US

(73) Assignee: AD TRUST CO., LTD., Tokyo (JP)

(21) Appl. No.: 11/937,290

(22) Filed: Nov. 8, 2007

(30) Foreign Application Priority Data
Nov. 9, 2006 (JP) 2006-304449

(51) Int. Cl. G06Q 40/00

(52) U.S. Cl. 705/39; 705/35

(57) ABSTRACT

Provided is a composite settlement system, including: a card; a terminal; and a management server, the card being capable of connecting to the management server via the card terminal, for storing management information on a card holder; the card terminal being capable of connecting to the card and the management server, the management server being capable of connecting to the card terminal and a computer of a financial institution, in which each of at least two business entities is allowed to execute a transaction and settlement with the financial institution based on an instruction issued from the card terminal connected to the card, whereby it is possible to improve convenience of a user by eliminating the need for carrying a plurality of cards different between business entities.

This application is based on and claims the benefit of priority from Japanese Patent Application No. 2006-304449, filed on Nov. 9, 2006, the content of which is incorporated herein by reference.

### BACKGROUND OF THE INVENTION

1. Field of the Invention

The present invention relates to a composite settlement system which allows two or more business entities to execute a transaction and settlement with a financial institution. In particular, the present invention relates to a composite settlement system in which, based on an instruction from a terminal connected to a card owned by a card holder, a certain amount is withdrawn by the card holder from an account at a financial institution, and the face value or number of points on the card are increased, or in which a game hall and the financial institution can execute such a transaction and settlement in order to purchase betting tickets and payout awards.

2. Description of the Related Art

Conventionally known prepaid cards used in a game hall include prepaid cards used for a ball dispensing machine in a “pachinko” parlor (see JP 2002-306793 A and JP 2004-303046 A). The prepaid card has a configuration such that cash is inserted into a ticket vending or charging device to store points on the prepaid card, and the prepaid card is inserted into a ball dispensing machine, to thereby receive balls based on the number of the points stored in the prepaid card. The prepaid card may also have a function of converting remaining balls into points and storing the points thereon. In addition, the points stored on the prepaid card can be exchanged for prizes.

However, these prepaid cards can be used only within a single game hall, and are based on a function of storing cash in the form of points which can be exchanged with balls, or temporarily storing the remaining balls as points. The ticket vending or charging device for a prepaid card, the ball dispensing machine, and prize exchanging machine exist separately, and the points are increased or decreased through a prepaid card which can access those machines.

Another conventionally known technique is a betting system having a composite settlement function in which cash or a partial deposit in a specific bank account is transferred into an account for settling a debit card, a credit card, electronic money, a prepaid card, etc. The cash or the specific secure bank account can be used to purchase betting tickets, admission tickets for race tracks, reserved seats, and items at kiosks, etc. (JP 2003-223528 A). The system includes: special membership subscription terminals that are connected, via communication lines including the Internet, to responding computers that are installed in race tracks, off-track betting booths, and stores outside those facilities, which include at least post offices, convenience stores, department stores, and supermarkets, and are affiliated with the promoter of the races; betting ticket vendors having a function of reading membership cards issued to special members, cash payout machines; and registers for food or drink or purchases, which are provided at the race tracks and off-track betting booths. The users of the system perform betting and receive payouts through the intermediation of the betting ticket vendors having a function of reading membership cards issued to special members and the cash payout machines, respectively.

The above-mentioned system has a wider usage area than a prepaid card for receiving balls that can be used only within a specific game hall, in that the betting ticket can be purchased and cash can be paid out even in a place outside the race tracks. However, all of the above-mentioned cards and systems are the same in that the cash or money deposited in a specific bank account is necessarily stored on the card as points or the amount itself, and the point or the amount itself is used for ball dispensing or purchasing of a betting ticket.

### SUMMARY OF THE INVENTION

In conventionally known cards and systems, the cash or the deposit within a specific bank account is put into a special management account to purchase a betting ticket by the debit card or the like, or the ball dispensing is performed with cash or the remaining balls stored on the card as points. Accordingly, those who wish to both place a bet and use a game hall need to carry both the above-mentioned debit card and a card for the game hall. In addition, those who wish to use another gambling facility associated with a different business entity or another game hall besides the horse racing exemplified above, need to carry a plurality of cards, which are different for different business entities. Furthermore, management of cards is troublesome because the cards have various functions, such as one for charging cash, and another for exchanging the remaining balls for points.

Furthermore, the conventionally cards and systems are used by appropriating the cash or the deposit from a secure bank account for the purchase, such that if the amount left as cash or a deposit within the specific secure bank account at the time of the purchase is insufficient as an amount required for purchasing a betting ticket or the like, the betting ticket or the like cannot be purchased even in cases where the required amount will apparently be paid/deposited by a predetermined date. This is inconvenient because a so-called credit function is not available.

In order to solve the above-mentioned problems, the present invention proposes a composite settlement system, including a card; a terminal; and a management server, the card being capable of connecting to the management server via the card terminal, for storing management information on a card holder; the card terminal being capable of connecting to the card and the management server, the management server being capable of connecting to the card terminal and a computer of a financial institution, in which each of at least two business entities is allowed to execute a transaction and settlement with the financial institution based on an instruction issued from the card terminal connected to the card.

According to the above-mentioned invention, through the card terminal and the management server that can be connected to the computer of the financial institution, the user can have each of the at least two business entities execute a transaction and settlement with the financial institution, which is extremely convenient. Hereinafter, the business entities include the management entities of gaming facilities (for example, “pachinko” parlors, game arcades, and bowling alleys) and the business entities of gambling establishments (such as horse racing, cycle racing, and boat racing), and may also include merchandise and service providers other than the above-mentioned entities.

The term “management information on a card holder” represents, for example, information including the card holder's address, name, birthday, credit limit amount. However, it is not specifically limited thereto. In this specification, the term “card” is used in a general sense, such as a portable medium that can be recorded with the above-mentioned information by an electronic means, and is not limited to a portable medium having a so-called card shape. Accordingly, other storage media such as a memory stick, devices such as a mobile phone into which another function is incorporated, and the like are collectively referred to as “card” in this specification.

Furthermore, the present invention proposes a composite settlement system, in which the card can store a face amount thereof; and the management server can cause the financial institution to execute such a transaction and settlement as to withdraw a certain amount from an account of the card holder, and increase the face amount of the card.

According to the above-mentioned system, the management server allows for the certain amount to be withdrawn from the card holder's account in the financial institution and the face amount of the card to be increased simultaneously, which eliminates the card holder's time and labor of temporarily withdrawing cash from the account and inserting the cash into a predetermined device to increase the face amount of the card. This also improves the safety of the card. In this specification, the term “face amount” represents information on the card, which replaces the cash or the amount of the account, and indicates a usable amount in a manner similar to that of cash during use of the card.

Furthermore, the preset invention proposes a composite settlement system, in which the card can store a service point thereof; and the management server can cause the financial institution and a service provider to execute such a transaction and settlement as to withdraw a certain amount from an account of the card holder, so as to increase the service points stored on the card, or decrease the service points in exchange for receiving a service or the delivery of a prize.

According to the above-mentioned system, similar to the system described above, the management server allows for the certain amount to be withdrawn from the card holder's account in the financial institution and the service point stored in the card to be increased simultaneously, which eliminates the card holder's time and labor of temporarily withdrawing cash from the account and inserting the cash into a predetermined device to increase the service points. Moreover, this also improves the safety of the card.

The present invention further proposes a composite settlement system in which the card terminal can receive cash and increase the face amount or the service points that are stored on the card, and can decrease the face amount or the service points in exchange for receiving a service or the delivery of a prize. The card terminal may be a dedicated machine or may be a so-called personal computer having certain functions. The card terminal may also be provided in a specific place within a game hall or the like, and may be provided in a home of each card holder.

According to the above-mentioned system, in addition to the withdrawal from the account at the financial institution, the insertion of cash into the card terminal can increase the face amount or the service points that are stored in the card, which greatly improves convenience. In addition, the insertion of the card into the card terminal or other such operations allows for a predetermined service or a prize to be received in exchange the face amount or the service points that are stored on the card.

Further, the preset invention proposes a composite settlement system, in which the management server is connected to a computer at a game hall, either via the financial institution or directly, and can have the game hall or the financial institution execute such a transaction or settlement relating to a purchase of a betting ticket or a payout for a winning ticket.

According to the above-mentioned system, through the card terminal and the management server, the card holder can not only purchase a betting ticket, but also receive a payout for a winning ticket between the financial institution and the game hall. Accordingly, this greatly improves greatly convenience.

The present invention further proposes a composite settlement system in which the management server is connected to the financial institution via a credit card company. In other words, according to the present invention, the management server is not necessarily directly connected to the financial institution, but may also or solely be connected to the credit card company, whereby the transaction and settlement is performed indirectly with respect to the financial institution based on the financial institution's credibility with respect to the credit card company. This configuration makes it possible to enhance the service based on the present invention even in cases where the direct transaction and settlement are not performed between the financial institution and the business entities administrating the management server.

Furthermore, the preset invention proposes a composite settlement system, in which when the face amount and service points are insufficient for receiving a service or a prize that is requested via the card terminal, the management server successfully performs the delivery of a service or a prize requested via the card terminal by withdrawing a certain amount from an account of the card holder of the financial institution and increasing the face amount and the service points of the card.

According to the above-mentioned system, even when the face amount and the service points are insufficient for receiving the service or the prize requested by the card terminal, if the management server can withdraw the certain amount from the card holder's account at the financial institution, that is, if a certain amount of cash is left in the account, it is possible to increase the face amount or the service points. Accordingly, the delivery of the service or the prize requested by the card terminal can be executed without delay.

According to the service point composite settlement system, in which when a balance of an account of the card holder with the financial institution is insufficient to receive a service or a prize that is requested by the card terminal, the management server successfully performs the delivery of the service or the prize that is requested by the card terminal by performing processing equivalent to the usage of a credit card within a predetermined limited amount, and increasing the face amount and the service points of the card.

According to the above-mentioned system, even when the face amount or the service points are insufficient to receive the service or the prize requested by the card terminal, and even when the balance of the card holder's account at the financial institution is insufficient for the certain amount, that is, even when a certain amount of cash is not left in the account, the increase in the face amount or the service points is permitted within the same limited amount as allowed for the usage of the credit card or within a predetermined limited amount allowed separately therefrom. Accordingly, even if the funds are insufficient at such a time, the delivery of the service or the prize requested by the card terminal can be executed without delay in anticipation of the future payment or deposit.

By causing each of at least two business entities to execute the transaction and settlement with the financial institution based on the instruction issued from the card terminal connected to the card, it is possible to greatly improve convenience with regard to the card user. Furthermore, with respect to each aspect of the present invention, all other effects other are also as described above.

### BRIEF DESCRIPTION OF THE DRAWING(S)

FIG. 1 is a flow diagram illustrating an embodiment of the present invention.

### DETAILED DESCRIPTION OF THE PREFERRED EMBODIMENTS

Hereinafter, a description will be made of an embodiment of the present invention with reference to the accompanying drawing(s). Note that the embodiment to be described with reference to the drawing is merely an explanatory example, and therefore, the present invention should not be limited to the embodiment(s), which will be described hereinafter.

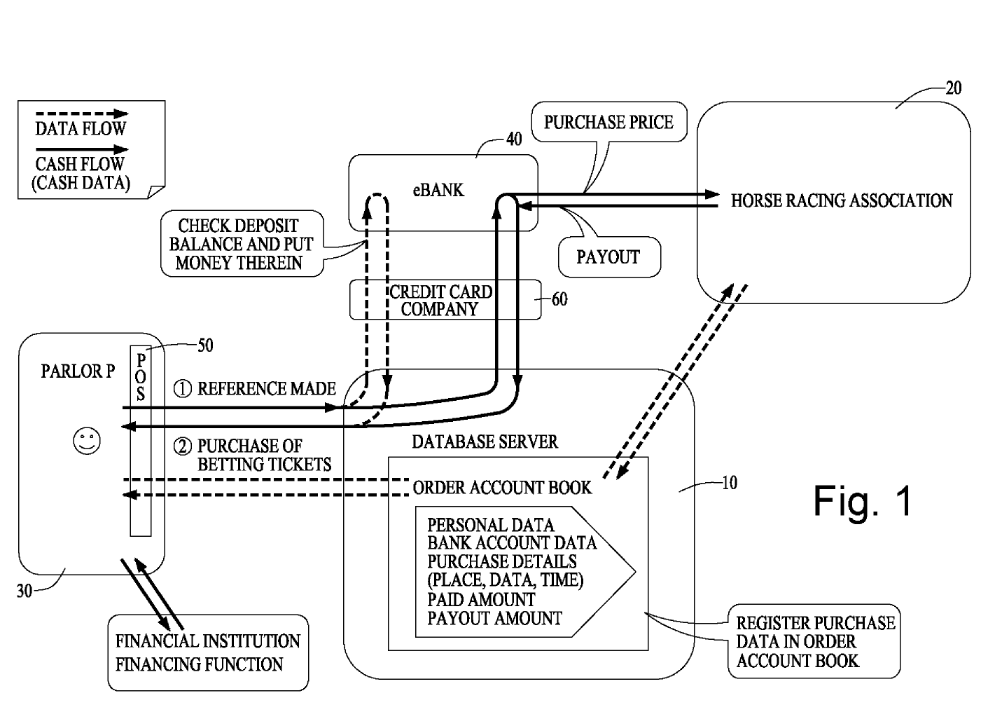

FIG. 1 is a diagram illustrating a configuration of a composite settlement system, in which a management server 10 allows each of two business entities, namely, each local horse racing association 20, and a game hall parlor P 30, to execute a transaction and settlement with an eBANK (financial facility) 40. A card user has a card (not shown), the card being electronically recorded with a card number required for access to the composite settlement system and electronically recorded with a face amount or service points, or both of these, in addition to management information on a card holder. The card may also be appropriately provided with a means for preventing a person other than the card holder from using the card acquired illegally, or a mechanism for preventing tampering of the face amount or the service points recorded on the card.

The card holder allows the information on the card to be read by a terminal 50, such as a POS installed in the game hall parlor P 30, in order to establish a communication link with the management server 10 via the POS, or the like. The terminal 50 may be continuously connected to the management server 10, or may be connected thereto via the Internet or the like continuously, or as deemed appropriate. The terminal 50 reads data written on the card, and as needed, validates whether the card is being used by an authorized user or not, by prompting the user to input a PIN code, or by another such means. Another measure for information security may implemented by also providing the card with a mechanism, such that the type or serial number of the terminal 50 is selectively discriminated or subjected to other processing, so as to allow the terminal 50 to read a specific item of information stored on the card, while prohibiting the terminal 50 from reading other items of information. For example, cases where information on a credit card, a financial facility, and the like is being concealed from a game hall-dedicated terminal set in a game hall.

The card holder can insert cash into a cash insertion device belonging to the terminal 50 to instruct the service points corresponding to an amount of the cash with respect to the card to be recorded. After processing, including the validation of the card user and confirmation of the amount of the inserted cash, the terminal 50 updates the service points of the card. This procedure does not always require a communication link between the terminal 50 and the management server 10.

In addition, after establishing the communication link with the terminal 50, the card holder can withdraw a certain amount from the user's own account within a specific financial facility 40 to instruct an appropriation of the amount as additional service points. In such cases, the instruction is transmitted from the terminal 50 to the management server 10, and the management server 10 performs the requested processing after confirming the financial facility, the account number, and the like used by the card holder. Certain processing including confirmation of the PIN code, confirmation of the account balance, and a withdrawal procedure is performed between the management server 10 and the financial facility 40. After completion of the processing, the management server 10 transmits an instruction to increase the service points to the terminal 50 for the card.

The management server 10 and the financial facility 40 may communicate with each other either directly, or via a credit card company 60. In particular, in cases where communicating via the credit card company 60, even if the account at the financial facility 40 requires no balance in order to purchase service points, the management server 10 can be instructed to perform the requested increase, in anticipation of the future deposit/payment of the required balance that is due to the user's credit with the credit card company 60. Even without the intermediation of the credit card company 60, the management server 10 may increase the service points to a predetermined amount in anticipation of the future deposit/payment.

The card holder may further use the terminal 50 for the card to issue an instruction to purchase a betting ticket from each local horse racing association 20, respectively. Also, in such cases, the instruction is first transmitted from the terminal 50 for the card to the management server 10. The management server 10 transmits the instruction to purchase a betting ticket to the financial facility 40, and the financial facility 40 processes a payment for the betting ticket and an issuance of the betting ticket with respect to each local horse racing association 20, respectively. Alternatively, the composite settlement system may be configured so that the management server 10 transmits the instruction to purchase a betting ticket to the financial facility 40 and each local horse racing association 20, the financial facility 40 and each local horse racing association 20 each respectively confirm the instruction to purchase a betting ticket with the other, and if required obtain confirmation, payment for the betting ticket, and perform the issuance of the betting ticket. The composite settlement system may be further configured so that when the betting ticket becomes a winning ticket, a dividend thereof can be paid out to the account at the financial facility 40 that has processed the payment for the betting ticket, or can be paid out through any payout counter or payout machine owned by each respective local horse racing association 20.

Furthermore, the card holder can obtain certain financing from the financial facility 40 through the terminal 50 for the card. The financing can be obtained as a payment to the card in the form of the face amount, or can be obtained in cash through the intermediation of a predetermined device. However, it is preferable that information regarding those transactions be transmitted to the management server 10, and that the management server 10 record a history of those transactions, and make the history available for future reference with respect to the card holder's credit.

The abovementioned description has been made in view of an embodiment of the present invention based on the configuration illustrated in FIG. 1. However, within the scope of the present invention, it is obvious that any medium that can electronically read/write certain information for recording may be used as the card, and therefore, the medium is not necessarily limited to a card shape. Moreover, any device that can exchange electronic data with the card may be used as the terminal for the card, regardless of whether the device is a dedicated terminal, or a general-purpose computer, or the location of the installed device. Furthermore, any game hall or any game hall, such as a pachinko parlor, a game arcade, the national race track, or a cycle race track may be used as the game hall or the each respective local horse racing association.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A composite settlement system, comprising:
a card;
a card terminal; and
a management server;
the card being capable of connecting to the management server via the card terminal, for storing management information on a card holder,
the card terminal being capable of connecting to the card and the management server,
the management server being capable of connecting to the card terminal and a computer of a financial institution,
wherein each of at least two business entities is allowed to execute a transaction or settlement with the financial institution based on an instruction issued from the card terminal connected to the card.

2. The composite settlement system according to claim 1, wherein the card can store a face amount thereon, and the management server can have the financial institution to execute such a transaction or settlement, so as to withdraw a certain amount from an account of the card holder, and increase the face amount of the card by the same amount.

3. A composite settlement system according to claim 2, wherein when the face amount is insufficient for receiving a service or a prize requested by the card terminal, the management server successfully performs a service or the delivery of a prize that is requested by the card terminal by withdrawing a certain amount from an account of the card holder with the financial institution, and increasing the face amount of the card.

4. A composite settlement system according to claim 1, wherein the card can store a face amount or an amount of service points thereon, or both, and the management server can cause the financial institution and a service provider to execute such a transaction or settlement by withdrawing a certain amount from an account of the card holder and increasing the face amount or the amount of service points stored on the card, or both, and decreasing either the face amount or the amount of service points, or both, in exchange for receiving a service or a prize.

5. A composite settlement system according to claim 1, wherein the card can store a face amount or an amount of service points thereon, or both, and wherein the card terminal can receive cash and increase the face amount or the amount of service points that are stored on the card, and can decrease the face amount or the amount of service points in exchange for a service and a prize.

6. A composite settlement system according to claim 1, wherein the management server is connected to a computer of a game hall via either the financial institution or directly, and can have the game hall and the financial institution execute such a transaction or settlement relating to a purchase of a betting ticket or a payout for a winning ticket.

7. A composite settlement system according to claim 1, wherein the management server is connected to the financial institution via a credit card company.

8. A composite settlement system according to claim 1, wherein the card can store a face amount or an amount of service points thereon, or both, and wherein a service or a prize is requested by the card terminal and either the face amount or the amount of service points are insufficient for receiving such requested service or prize, the management server successfully performs the requested service or the delivery of the requested prize by withdrawing a certain amount from an account of the card holder with the financial institution, and increasing one of the face amount or the amount of service points of the card.

9. A composite settlement system according to claim 1, wherein the card can store a face amount and an amount of service points thereon, and wherein a service or a prize is requested by the card terminal and a balance of an account of the card holder with the financial institution is insufficient for receiving the requested service or prize, the management server successfully performs the service or delivers the prize by performing processing equivalent to usage of a credit card within a predetermined limited amount, and increasing the face amount or the amount of service points of the card.
